(19) United States
(12) Patent Application Publication
(10) Pub. No.: US 2015/0207780 A1
(43) Pub. Date: Jul. 23, 2015

(54) Anonymous Network Operation

(71) Applicant: Jonathan Grier, Pikesville, MD (US)

(72) Inventor: Jonathan Grier, Pikesville, MD (US)

(21) Appl. No.: 14/601,297

(22) Filed: Jan. 21, 2015

Related U.S. Application Data
(60) Provisional application No. 61/929,588, filed on Jan. 21, 2014.

(51) Int. Cl. H04L 29/06

(52) U.S. Cl. CPC H04L 63/0407

(57) ABSTRACT

Systems and methods for anonymous operation over a non-private network is provided. A mirror of at least a portion of the network is generated and stored on one or more secure machines such that a user is capable of performing one or more standard network operations on the mirror. If real-time network information is desired, the user sends a request to a virtual machine that performs the request as if it originated at the virtual machine then forwards the retrieved information to the user's machine.

### CROSS REFERENCE TO RELATED APPLICATIONS

This application claims the benefit of the filing date of U.S. provisional patent application No. 61/929,588 entitled “Anonymous Network Operation”, which was filed on Jan. 21, 2014, by the same inventor of this application. That provisional application is hereby incorporated by reference as if fully set forth herein.

### FIELD OF THE INVENTION

The invention relates generally to browsing a network and more particularly but not exclusively to methods for anonymous web browsing.

BACKGROUND OF THE INVENTION

Using the Internet (also referred to herein as the Web or the Cloud has become an indispensable part of life for most people, governments and businesses. However, Internet browsing provides third parties (e.g. search engine providers, website maintainers, Internet Service Provider's (ISPs), digital advertising agencies and unscrupulous parties such as hackers or eavesdroppers) with a detailed look at the topics that are searched. Indeed, Google boasts it has been able to track the spread of the flu with better accuracy than the Center for Disease Control (CDC), just by monitoring searches. Search engine providers routinely track information related to search activity and aggregate this information to build detailed profiles. Conventional encryption technology, such as secure sockets layer (SSL), protects much of this information, but does not protect identities or browsing histories and provides no protection from search engine providers or website operators themselves.

Exposure of our interests and activities may merely be a nuisance to some, but for those who require a certain level of secrecy this breach in security is intolerable. However, short of forgoing usage of the Web, no acceptable enterprise scale solution is available. Consequently, many are faced with a disappointing choice: either accept exposure of their areas of interest to third parties, or be deprived of a vital source of information and communication. Existing technology suffers from relatively lengthy delays and security and scalability issues.

It would thus be advantageous to create a system and method for anonymously browsing the Web. It would also be advantageous to provide such a system and method that is scalable. It would further be advantageous to provide such a system and method that is secure. It would still further be advantageous to provide such a system and method that minimizes delays entered into the browsing experience.

### BRIEF SUMMARY OF THE INVENTION

Many advantages of the invention will be determined and are attained by the invention, which in a broad sense provides methods for anonymously browsing a public network (e.g. the Internet). In at least one embodiment a method is provided for operating anonymously over a public network. The method of that embodiment(s) includes duplicating at least a portion of the network and isolating the duplicated portion of the network from the network. The method also includes allowing operations (e.g. searches) to be performed on the isolated, duplicated portion of the network and enabling the duplicated portion of the network to be selectively updated from the network with an updating operation (e.g. real-time or substantially real-time search) being performed during the operations. The updating operation is performed indirectly.

In one or more implementations of the invention, a method is provided for anonymously browsing a network. The method includes performing an operation (e.g. searching) over the network and mixing additional network traffic with the operation prior to performing the operation via the network.

In one or more implementations of the invention, a method is provided for anonymously browsing a network. The method includes connecting to a pool of disposable virtual machines, transmitting a network operation request to at least one of the virtual machines, and having the at least one virtual machine perform the network request as if the request originated at that virtual machine.

The invention will next be described in connection with certain illustrated embodiments and practices. However, it will be clear to those skilled in the art that various modifications, additions and subtractions can be made without departing from the spirit or scope of the claims.

### BRIEF DESCRIPTION OF THE DRAWINGS

For a better understanding of the invention, reference is made to the following description, taken in conjunction with the accompanying drawings, in which like reference characters refer to like parts throughout, and in which:

FIG. 1 is a block diagram illustrating an offline browsing system in accordance with one or more embodiments of the invention;

FIG. 2 is an illustration of the offline anonymous network access system according to FIG. 1 connecting to a non-private network in accordance with one or more embodiments of the invention.

The invention will next be described in connection with certain illustrated embodiments and practices. However, it will be clear to those skilled in the art that various modifications, additions, and subtractions can be made without departing from the spirit or scope of the claims.

### DETAILED DESCRIPTION OF THE INVENTION

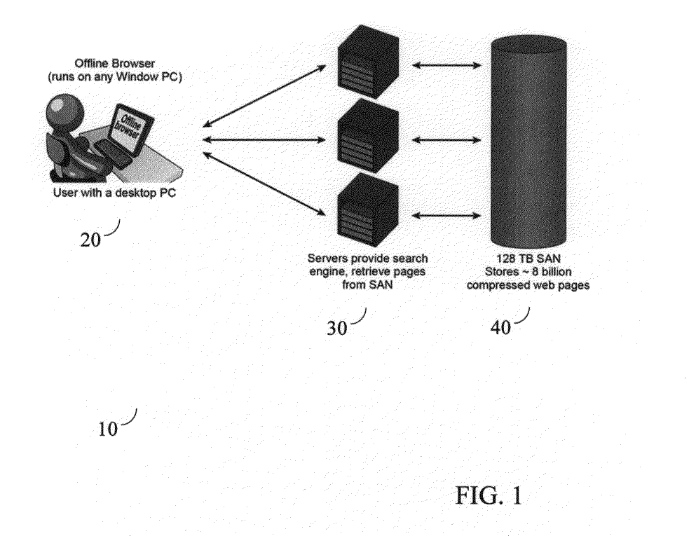

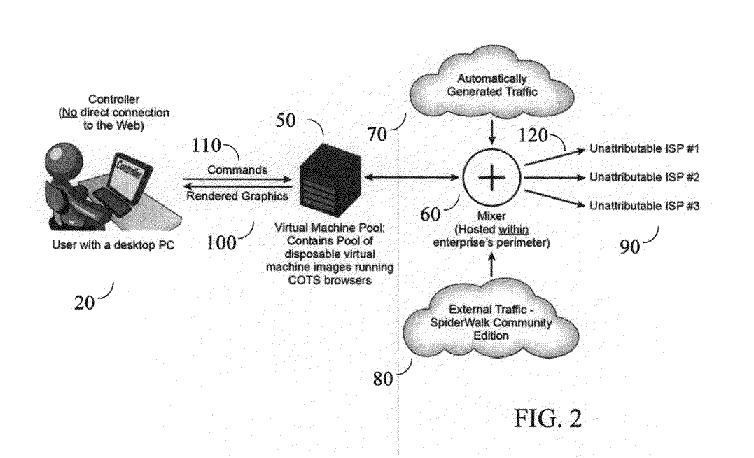

Referring to the drawings in detail wherein like reference numerals identify like elements throughout the various figures, there is illustrated in FIGS. 1-2 systems and methods for anonymous operation over a non-private network. The principles and operations of the invention may be better understood with reference to the drawings and the accompanying description.

In a preferred embodiment as illustrated in FIGS. 1 and 2 systems and methods are illustrated for anonymous operation on a non-private network (e.g. a public network such as the Internet or some other semi-private network). For purposes of explanation, the following description will be limited to the Internet, however, those skilled in the art will recognize that the invention and the description is not so limited. An aspect of the invention includes offline browsing 10: that is, searching and browsing an offline mirror 40 of the Web, without live interaction with websites and servers. This has the capability of potentially providing full operational security (OPSEC) at all levels against all threats, known and unknown. Those skilled in the art will recognize that no system is perfect and even the systems and methods of the invention cannot predict all future attacks. For example, this system 10 while apparently impervious to external cyber-attacks, does not prevent human infiltration and espionage from within the entity. Thus, offline operation 10 is best suited as a first tier component of a full anonymity system. However, those skilled in the art will recognize that the offline system 10 could make up the entirety of the system and still fall within a scope of the invention.

Since the invention includes offline operations on a mirror 40 of the network, the following design choices will be considered: How many pages will the archive contain? Will they be compressed or uncompressed? How often will they be updated? What methods will be used to collect, store, deliver, search, and browse them? At what cost? The Common Crawl is a publicly available offline archive of over 5 billion web pages. The Common Crawl is updated using 180 Amazon EC2 instances over four days, at an approximate cost of $1000, and requires 81 TB storage. The Common Crawl is updated only twice a year; but, at those costs, weekly updates are feasible. Open source web scale crawlers, such as Apache Nutch, are readily available, as are open source search engines, such as Apache Lucene. A 96 TB storage access network (SAN), which can host the entire archive within an entity's control, currently costs $48,000. Thus, many of the components of a full offline browsing environment 10 are publicly available at relatively reasonable costs. Thus a private entity, government entity or a trusted third party entity could afford to make this service available to its employees, personnel or customers. What is not available is an integrated system or the idea to create and employ such a system including all of these elements, which provides a disconnected, browser like user interface and search engine.

The system also includes a pool of virtual machine images (VMs) 50 running on a server; each image is isolated from any identifying information and provides a working browser. Those skilled in the art will recognize that the number of virtual machines 50 is a design choice and that they can be located on the same server and/or on multiple servers and still fall within a scope of the invention. When operating on the non-private network direct human interaction with the virtual machine 50 is limited or more preferably eliminated; instead, all control is done via an application 20 built for the purpose of secure control, located on a different machine than the VM 50, which issues commands 110 to the VM 50 and receives rendered images 100 back from it. For example, the VM 50 may send to the control application a rendered image 100 of a web page; the user moves the mouse in the control application 20 and clicks on a link; the control application 20 then instructs 110 the VM 50 to load that URL, and the cycle repeats. Thus there is a buffer/barrier between the user's device 20 and Internet. Those skilled in the art will recognize that while not preferred, one or more of the VMs 50 may be collocated on the same machine with the control application 20 and still fall within a scope of the invention.

As a result of the architecture of the invention, security does not rest on browser extensions that plug individual holes, but instead provides connection to the Web via a pool of disposable, isolated, identification free virtual machines 50. A central controller 20 manages this pool of virtual machines 50, restoring them to a baseline state after each use, returning them to the pool after a session has completed, and, to avoid any type of long term tracking, disposing of images after a fixed period of time and replacing them with new ones. Those skilled in the art will recognize that the controller 20 need not be centralized, but could be distributed. Additionally, while not preferred, the VM's 50 could be returned to a baseline state after a certain number of uses, returned to the pool after a certain number of uses, and could dispose of images based on a random time period or a triggering event rather than based on a time period and still fall within a scope of the invention.

By way of a non-limiting example, one or more embodiments of the invention may be employed as follows: an army sergeant is at a base planning an urgent mission. His task is to assess an area for possibilities of collateral damage. The mission is scheduled to take place in less than 72 hours, and so he needs to act fast, making the Web an invaluable tool. The sergeant begins by opening his OPSEC-cleared browser (hereafter referred to as “SpiderWalk”). By default, it starts in offline mode, so no traffic leaves his network. Those skilled in the art will recognize that the default mode is a design choice) Instead, searches and browsing are done on headquarters' local archive 40 of 8 billion web pages, stored on their 128 TB SAN 40. Using the built-in search engine, he searches maps, directories, phone listings, and anything else he can find pertaining to the area, and determines that there are two buildings he needs to look at further: an elementary school and a diner. The sergeant bookmarks their websites, as well as a few other relevant local pages. The web pages indicate that the school will be vacant at the time of the mission, and that the diner has been closed for several weeks. The sergeant wants to confirm that this is still the case. He knows that the local archive 40 is only updated monthly (design choice—could be more or less often), via a physical delivery of storage device(s)(or via some other secure method of delivery), so he wants to check the live websites to see if anything has changed in the last month. He switches to online mode and clicks on his first bookmark.

SpiderWalk now connects to the Web and fetches the latest version of the page. The connection is not direct, but is mixed and anonymized (60, 70, 80, 90). SpiderWalk generates random Web traffic 70, simulating human web usage, and mixes it 60 in with the request for the school webpage. Furthermore, live traffic 80 from users of a publicly available or at least less private network version of SpiderWalk may pass through the network and be mixed in 60 with the traffic, even before it leaves headquarters. These traffic sources help camouflage the sergeant's requests from the outset. This mixed traffic is all sent over encrypted tunnels 120 to disposable relays 90: small ISP connections located throughout the country, controlled by the service but not directly attributable to it. These relays 90 are used for a few months (or some other period of time depending upon the design choice) and then discarded and replaced with new ones.

The relays 90 add about a second of latency to the page load, but since most of the searching has been done offline, it is not that disruptive. He visits the school's website and checks that their schedule has not changed. To him, it appears as if he is using a regular browser. But, behind the scenes, his SpiderWalk browser is connecting to a pool of virtual machines (VMs) 50. Every time or almost every time he clicks a link or moves his mouse, commands 110 are sent to a randomly selected VM 50, which fetches the page and sends the rendered contents 100 back to his device 20. There is no direct connection between his machine 20 and the outside world: SpiderWalk is a complete mediator.

Each VM is randomly selected from a pool 50. Every VM in the pool 50 features a commercial off the shelf (“COTS”) browser like Firefox or Chrome and mimics the behavior of a COTS device. (Those skilled in the art will recognize that the browser need not be a COTS browser, but it is preferred). SpiderWalk automatically manages the VM pool 50, using the same VM for a single session (up to 15 minutes or some other time period determined based upon the design choice of the system or possibly a random time period) on one website, then recycling it and randomly selecting a new one. This way, no one distinguish SpiderWalk from COTS browsers: Chatting and JavaScript may be employed, Ajax and plugins may be supported, and the browsing experience is routine. No one can tell that the user is using SpiderWalk and not a COTS computer. But since the VMs 50 have a lifetime of only 15 minutes before being recycled, they simply have no information to disclose. Every few months (or some other time period), new VM images may be added to the pool, and older ones may be removed. Those skilled in the art will recognize that the SpiderWalk browser could change VMs after a set number of operations rather than based on a session or a set time period and still fall within a scope of the invention.

The sergeant also reviews the diner's page. It states that the diner will be back in business “any day now”. This may pose a concern for collateral damage, and the sergeant has the information necessary to bring this to his commanding officer's attention.

Having thus described preferred embodiments of the invention, advantages can be appreciated. Variations from the described embodiments exist without departing from the scope of the invention. For example, the controller may protect against human error (e.g. accidentally submitting identifying information) by using data loss prevention (“DLP”) technology to monitor all typing. Additionally, the system can randomize, inject noise, or completely reconstruct the key and mouse stream to prevent identification of users over the Web based on their typing and mouse patterns. The system may employ only one of the methods (e.g. offline searching, virtual machines or mixing in traffic) or they could use any combination of two or more of these strategies. Additionally, the anonymous browser may be the only browser installed on the machine to prevent accidental standard use of the Internet. While not preferred, it may also include an unsecured browser. Thus it is seen that systems and methods for anonymous operation over a non-private network are provided. Although particular embodiments have been disclosed herein in detail, this has been done for purposes of illustration only, and is not intended to be limiting with respect to the scope of the claims, which follow. In particular, it is contemplated by the inventors that various substitutions, alterations, and modifications may be made without departing from the spirit and scope of the invention as defined by the claims. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

Insofar as embodiments of the invention described above are implemented, at least in part, using a computer system, it will be appreciated that a computer program for implementing at least part of the described methods and/or the described systems is envisaged as an aspect of the invention. The computer system may be any suitable apparatus, system or device, electronic, optical, or a combination thereof. For example, the computer system may be a programmable data processing apparatus, a computer, a Digital Signal Processor, an optical computer or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by one or more application specific integrated circuits and/or optical elements. Suitably, the computer program can be stored on a carrier medium in computer usable form, which is also envisaged as an aspect of the invention. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

It is accordingly intended that all matter contained in the above description or shown in the accompanying drawings be interpreted as illustrative rather than in a limiting sense. It is also to be understood that the following claims are intended to cover all of the generic and specific features of the invention as described herein, and all statements of the scope of the invention which, as a matter of language, might be said to fall there between.

Having described the invention, what is claimed as new and secured by Letters Patent is:

1. A method of operating anonymously over a public network comprising:
duplicating at least a portion of the network;
isolating said duplicated portion of the network from said network;
enabling a network operation to be performed on said isolated, duplicated portion of the network;
enabling said duplicated portion of the network to be selectively updated from the network with an updating operation performed during said operation; wherein said updating operation is performed indirectly.

2. The method according to claim 1 further comprising:
mixing network traffic from users of the network with said updating operation prior to performing said updating operation via said network.

3. The method according to claim 2 further including transmitting said mixed traffic over encrypted tunnels to disposable relays.

4. The method according to claim 3 further including replacing at least one of said relays with at least one different relay after a period of time.

5. The method according to claim 1 further comprising:
generating random network traffic and mixing said random network traffic with said updating operation prior to performing said updating operation via said network.

6. The method according to claim 5 further including transmitting said mixed traffic over encrypted tunnels to disposable relays.

7. The method according to claim 6 further including replacing at least one of said relays with at least one different relay after a period of time.

8. The method according to claim 1 wherein said updating operation includes connecting to a pool of disposable virtual machines and performing said updating operation via at least one of said virtual machines.

9. The method according to claim 8 further including replacing at least one of said virtual machines with at least another virtual machine after a period of time.

10. A method of operating anonymously over a non-private network comprising:
performing an operation over the network; and,
mixing additional network traffic with said operation prior to performing said operation via said network.

11. The method according to claim 10 wherein said additional network traffic includes network traffic from multiple users of the network.

12. The method according to claim 10 further comprising:
generating random network traffic; and,
wherein said additional network traffic includes said random network traffic.

13. The method according to claim 10 further including transmitting said mixed traffic over encrypted tunnels to disposable relays.

14. The method according to claim 13 further including replacing at least one of said relays with at least one different relay after a period of time.

15. The method according to claim 10 wherein said operation includes remotely connecting to a pool of virtual machines and performing said updating operations via at least one of said virtual machines.

16. The method according to claim 15 further including replacing at least one of said virtual machines with at least another virtual machine after a period of time.

17. A method of operating anonymously over a non-private network comprising:
connecting from a control application to a pool of virtual machines;
transmitting from said control application, a network operation request to at least one of said virtual machines; and,
said at least one virtual machine performing said network request as if said request originated at said at least one virtual machine.

18. The method according to claim 17 wherein said pool of virtual machines is remote from said control application.

19. The method according to claim 17 wherein said pool of virtual machines and said control application are located on a common machine.

20. The method according to claim 17 further including replacing at least one of said virtual machines with at least another virtual machine after a period of time.
